(19) United States
(12) Patent Application Publication
(10) Pub. No.: US 2026/0055005 A1
(43) Pub. Date: Feb. 26, 2026

(54) SELECTIVE EXTRACTION AND SEPARATION OF VANADIUM AND IRON

(71) Applicant: TCM Research Ltd., Co Clare (IE)

(72) Inventors: Dmitri S. Terekhov, Ontario (CA); Colwyn S. van der Linde, Boksburg (ZA)

(21) Appl. No.: 19/103,631

(22) PCT Filed: Aug. 11, 2023
(86) PCT No.: PCT/EP2023/072306

§ 371 Date: Feb. 13, 2025

Related U.S. Application Data
(60) Provisional application No. 63/397,945, filed on Aug. 15, 2022.

(51) Int. Cl. C01G 31/02; B01D 7/02; C01G 49/02; C01G 49/10; C22B 1/08; C22B 34/22

(52) U.S. Cl. CPC C01G 31/02; B01D 7/02; C01G 49/02; C01G 49/10; C22B 1/08; C22B 34/22

(57) ABSTRACT

This disclosure relates to a process for selective extraction and separating vanadium and iron using a method of chlorinating vanadium-containing iron oxide ores. More particularly, the disclosure relates to a process for producing vanadium oxytrichloride (VOCl₃) and iron trichloride (FeCl₃) in a moving bed chlorinator by reacting chlorine and carbon monoxide with vanadium iron oxide materials. In addition, this disclosure describes removing other chlorides with the exemption of vanadium and iron chlorides from the exhaust stream from the reactor by creating a conversion temperature zone at the top of the reactor. Furthermore, the invention discloses removing impurities from an exhaust gas stream to purify carbon dioxide and it also includes a closed-loop capture in the process in order to convert carbon dioxide to carbon monoxide.

### CROSS-REFERENCE TO RELATED APPLICATIONS

This application claims the benefit of priority from U.S. Provisional Patent Application 63/397,945 filed Aug. 15, 2022, the entire disclosure of which is herein incorporated by reference in its entirety.

### TECHNICAL FIELD

This disclosure relates to methods and systems for selective extraction and separation of vanadium and iron from vanadium-containing iron oxide ores and concentrates.

### BACKGROUND

Approximately 90% of global vanadium supply originates from vanadium titanomagnetite ores which also contain significant amounts of iron. However, conventional processes for vanadium extraction do not realize the iron value, focusing only on extraction of vanadium. A typical conventional process includes roasting an ore or concentrate at a high temperature and therefore, it generates a high carbon dioxide footprint.

U.S. patent 3,925,057A (1973) describes selective extraction of iron from titanious material, including ilmenite, with recycling of chlorine by oxidation of FeCl₃ with oxygen. A roasted feed material and calcined petroleum coke were continuously charged to a fluidized bed reactor and chlorinated by a gas mixture of chlorine and oxygen, but only iron was extracted from the feed material.

European patent EP02134807A2 (1987), where partial oxidation of hydrocarbon fuel is used as a reductant. A feed material is reduced with hydrocarbon fuel and some oxygen using a combustion reaction to maintain the required temperature above 900° C. A reduced feed was chlorinated with a gas mixture containing chlorine gas to extract iron selectively. Produced FeCl₃ was oxidized with oxygen to produce iron oxide and chlorine, and chlorine gas was recycled back into the process.

U.S. Pat. No. 3,244,509 (1966) is similar to the above process, but a reduction-chlorination and oxidizing-chlorination step was separated in two processes. During the reduction-chlorination step, other metal chlorides were produced, including TiCl₄, SiCl₄ and AlCl₃. These metal chlorides were removed from the gas mixture in the oxidizing-chlorination reactor by reacting with fresh iron ore. Syngas made from reforming coal, carbon monoxide and hydrogen, was used as the reductant. Chlorine gas was recovered by oxidation of FeCl₃ with oxygen. Phosphorus was recovered in the form of POCl₃ and hydrolyzed to phosphoric acid. Formed in the reduction-chlorination step, PCl₃ reacted with iron oxide to form POCl₃ and FeCl₃. It is reported in the patent, that the process forms volatile vanadium oxychloride, while all other metal chlorides reacted with iron oxide without forming volatile oxychlorides.

U.S. Pat. Nos. 4,288,411 (1981) and 4,220,629 (1980) describe the usage of metal chlorides, for example, TiCl₄, and SiCl₄, in producing iron and aluminum chlorides. These patents illustrate a potential for selective extraction of iron and aluminum by forcing TiCl₄ and SiCl₄ reactions with correspondent oxides. In U.S. Pat. No. 7,658,894 (2010), CO is used as a reductant for selective extraction of iron from chrome. NaCl was used as a catalyst, and the Cr/Fe ratio in a material was increased from 1.88 to 16.9 by using selective extraction of iron. U.S. Pat. No. 1,415,028 (1922) reports the basic reaction between vanadium oxide, carbon and chlorine is known from

U.S. Pat. No. 3,355,244 (1965) describes a process for preparing VOCl₃ by maintaining vanadium oxide, a carbon and an inert diluent in a fluidized bed and fluidizing the bed with chlorine. The gaseous reaction products recovered overhead from the fluidized bed are initially passed into a cyclone separator to remove entrained solids. The resulting crude vanadium VOCl₃ gases are then fed to a quench condenser, wherein they are quenched in a counter-current circulation stream of liquid VOCl₃. The condensed VOCl₃ product is then treated, e.g., by fractional distillation, to obtain a highly purified VOCl₃ product. However, the gaseous effluent stream from this process contains unrecovered vanadium chlorides and unreacted chlorine, necessitating the use of expensive auxiliary equipment to remove these products and reducing yields by wasting chlorine vanadium and vanadium chlorides.

British U.S. Pat. No. 1,308,738 (1970) describes chlorination of vanadium pentoxide in a fluidized bed in the presence of carbon at 425° C. The product stream containing predominantly VOCl₃ is then chlorinated in a second fluidized bed at 600° C. in the presence of activated carbon to produce a product stream containing predominantly vanadium tetrachloride and minor quantities of VOCl₃. The VOCl₃ and vanadium tetrachloride are then separated by fractional distillation. Most of the chlorination reactions were done in a fluidized bed reactor; however, U.S. Pat. No. 3,149,911 (1960) describes a moving bed reactor for the production of TiCl4. A material is fed to the top of the reactor, and chlorine gas is passed through the reactor upward.

Recovery of process gases is described in several patents reviewed above, nevertheless is limited to chlorine recovery and recycling. After condensing iron or vanadium chlorides, the exhaust gas mixture mainly contains CO2 and this mixture is released into the atmosphere.

The conversion of carbon dioxide to carbon monoxide is described in several patents. U.S. Pat. No. 10,494,728 reports production of CO in a solid oxide electrolysis cell (SOEC) from CO₂. In the invention, a mixture of oxygen and carbon monoxide is produced on one side of the cell, and a mixture of CO and CO₂ on the other side of the process. The pressure swing adsorption (PSA) process separates carbon monoxide from carbon dioxide, making the process more complicated. A similar process is explained in PCT patent application WO 2013131778 A2. 90% pure CO is produced from CO₂. PCT patent application WO 2015189064A1 describes the production process of phosgene from chlorine and carbon monoxide, where CO is produced from CO₂ in a solid oxide electrolysis cell (SOEC).

However, there remains the need in the field for methods and systems performing selective extraction and separation of vanadium and iron from vanadium-containing ores. Today, more than ever, there also remains the need in the field for extraction methods and systems that minimize a release of carbon dioxide into the atmosphere.

### SUMMARY

This disclosure provides methods and systems for selective extraction and separation of vanadium and iron with a substantial technical advantage of more effective utilization of natural resources. The disclosed herein methods and systems minimize a release of CO₂ into the atmosphere, reducing a carbon footprint.

In one aspect, the disclosure relates to a method for extracting vanadium and iron from a vanadium ore containing at least vanadium and iron, the method comprising:
i. reacting the vanadium ore with a gas mixture comprising carbon monoxide (CO) and chlorine (Cl₂) in the presence of carbon dioxide (CO₂) at a first elevated temperature, wherein the first elevated temperature is in the range from about 850 to about 1000° C. and thereby producing a mixture of volatile metal chlorides comprising iron chloride (FeCl₃) and vanadium oxytrichloride (VOCl₃);
ii. exposing the mixture obtained in step i. to a second temperature, the second temperature being in the range from about 750 to about 550° C. and collecting a gas mixture that comprises iron chloride (FeCl₃), vanadium oxytrichloride (VOCl₃) and carbon dioxide (CO₂);
iii. passing the gas mixture collected in step ii. through a desublimator and precipitating iron chloride solid crystals from the gas mixture, thereby depleting the gas mixture of iron chloride;
iv. passing the gas mixture obtained in step iii. which comprises vanadium oxytrichloride (VOCl₃) and carbon dioxide (CO₂), but is depleted of iron chloride (FeCl₃) through a vanadium oxytrichloride condenser and producing liquid vanadium oxytrichloride;
v. oxidizing iron chloride solid crystals obtained in step iii. in the presence of a carbon dioxide and oxygen gas mixture into iron oxide; and
vi. oxidizing vanadium oxytrichloride obtained in step iv. in the presence of a carbon dioxide and oxygen gas mixture into vanadium oxide.

The embodiments of the method may include those, wherein the vanadium ore is one or more of the following: titanomagnetite, magnomagnetite, magnetite, rutile, ilmenite, or any mixture thereof. Some preferred embodiments of the method may further include recycling carbon dioxide and producing a CO/CO₂ gas mixture and/or O₂ /CO₂ gas mixture in a solid oxide electrolysis cell (SOEC). In yet another embodiment, the method may further comprise recycling carbon monoxide.

In particularly preferred embodiment, steps i. and ii. are performed in a chlorination reactor operating at 3 different temperature zones, a first temperature zone being used for carrying step i; a second temperature zone being used for carrying step ii and a third temperature zone being used for scrubbing carbon dioxide prior to recycling it, wherein the third temperature zone is operated preferably at a temperature range from about 450 to about 350° C.

In any of the embodiments for the method step i. is performed with carbon monoxide (CO) and chlorine (Cl₂) in the presence of carbon dioxide (CO₂) mixed at a ratio 1:1:1 by volume.

In some preferred embodiments, the desublimator in step iii may be operated at a temperature in the range from about 120 to about 150° C.

Some preferred embodiments of the method include those, wherein the vanadium oxytrichloride condenser in step iv. is operated at a temperature in the range from about-to about +5° C.

In particularly preferred embodiments, carbon dioxide and/or carbon monoxide may be recycled through a close-loop capture.

In another aspect, this disclosure relates to a system for extracting vanadium and iron from a vanadium ore and separating vanadium from iron, the system comprising:
a chlorination reactor 1 having three different temperature zones: chlorination I, conversion II, and scrubbing III, wherein the chlorination reactor is a chamber having a volume enclosed by a wall and having a length from a bottom to a top of the chamber, and wherein the three zones are located along the length of the reactor, one after another, the chlorination zone I being the closest to the bottom of the reactor, followed by the conversion zone II in the middle and the scrubbing zone III be located after the conversion zone II, the scrubbing zone III being the closest to the top of the reactor;
one or more desublimators 2,
one or more condensers 3,
oxidizers 4 and 5, and
a solid oxide electrolysis cell (SOEC) 7.

In some preferred embodiments of the system, the system may further comprise one or more liquid storage tanks for collecting and storing liquid vanadium oxytrichloride.

In some preferred embodiments of the system, the chlorination reactor may contain one or more inlets for receiving the vanadium ore and wherein the inlets are located at or near the top of the reactor and wherein the system may further include a conveyor capable of moving the vanadium ore from the top to the bottom of the reactor.

In some preferred embodiments of the system, the reactor may include an exhaust line which can be connected to an outlet gas nozzle of the reactor, the exhaust line capable of connecting the reactor to one or more desublimators, the exhaust line being used for removing a gas mixture that comprises iron chloride (FeCl₃), vanadium oxytrichloride (VOCl₃) and carbon dioxide (CO₂) from the conversion Zone II of the reactor to one or more desublimators.

Some preferred embodiments of the system may include those, wherein the one or more desublimator may further include an exhaust line for connecting the one or more desublimators to one or more vanadium oxytrichloride condensers, the exhaust line being an outlet from the desublimator and suitable for passing an iron chloride depleted gas mixture from the desublimator to the vanadium oxytrichloride condenser.

In some preferred embodiments, the chlorination reactor may comprise one or more of the following elements:
at least two inlets, a first inlet being located at or near the bottom of the chlorination reactor, the first inlet being suitable for supplying a gas mixture comprising carbon monoxide (CO), chlorine (Cl₂) and carbon dioxide (CO₂) to the chlorination reactor, and a second inlet being located at or near the scrubbing zone III for receiving carbon dioxide for scrubbing from at least one vanadium oxytrichloride condenser;
at least two outlet gas nozzles, a first outlet gas nozzle being located in or after the conversion zone II, but before the scrubbing zone III, the first outlet gas nozzle being connectable to an exhaust line, the first outlet gas nozzle being used for removing a gas mixture that comprises iron chloride (FeCl₃), vanadium oxytrichloride (VOCl₃) and carbon dioxide (CO₂) from the conversion Zone II of the chlorination reactor to one or more desublimators; and a second outlet gas nozzle located at or near the top of the chlorination reactor for removing recycled carbon dioxide (CO₂) from the chlorination reactor;
a feed material hopper to feed ore to the chlorination reactor; and/or a screw conveyer for removing residue from the chlorination reactor.

Further embodiments of the system include those, wherein the desublimator may include a heat exchange unit and a bottom storage space for iron chloride solid crystals.

In yet further embodiments of the system, the condenser may include a storage tank and purification column.

In some preferred embodiments of the system, the SOEC unit may be equipped with at least two gas pumps.

In yet another aspect, this disclosure relates to a use of the system according to any of the embodiments, for performing the following method:
continuously feeding solid pellets to the chlorination reactor from the feed bin at the top of the reactor;
moving feed pellets downward through three heating zones of the reactor: scrubbing, conversion and chlorination;
introducing a gas mixture of Cl₂ /CO/CO₂ from the bottom of the reactor and chlorinating feed material pellets in the chlorinating zone;
passing produced a gaseous mixture of metal chlorides through heated feed material in the conversion zone and removing all metal chlorides except for FeCl₃ and VOCl₃;
withdrawing a purified gas mixture containing FeCl₃ and VOCl₃ using a gas outlet line located above the conversion zone;
passing the gas mixture through FeCl₃ one of two desublimators and precipitating solid iron trichloride;
switching to the second desublimator when the first desublimator is full and subliming FeCl₃ from a desublimator to an iron chloride oxidizer and producing iron oxide;
condensing VOCl₃ in a liquid condenser and discharging liquid VOCl₃ into a storage tank;
evaporating VOCl₃ from the storage tank through purification column to VOCl₃ oxidizer and producing vanadium oxide;
passing an exhaust gas mixture through heated feed in the scrubbing zone to remove traces of chlorine compounds;
using the resulting cleaned gas mixture to convert CO₂ to CO/CO₂ and O₂/CO₂ gas mixtures;
recycling produced CO/CO₂ gas mixture to Cl₂ /CO/CO₂ gas stream for use in chlorination reactor;
using O₂/CO₂ in iron chloride and VOCl₃ oxidizers to produce iron and vanadium oxides and chlorine gas; and
recycling produced chlorine gas to Cl₂ /CO/CO₂ gas stream for use in chlorination reactor.

### BRIEF DESCRIPTION OF THE DRAWINGS

FIG. 1 is a block diagram of a method for selective extraction and separation of vanadium and iron from a vanadium ore according to this disclosure.

FIG. 2 is a schematic of a system and method according to this disclosure.

### DETAILED DESCRIPTION

This disclosure provides methods and systems for selective extraction and purification of vanadium and iron from vanadium-containing ores.

Present methods can be performed with any vanadium ore which may be any mineral containing at least vanadium and iron. Suitable vanadium ores include, but are not limited to, titanomagnetite, magnomagnetite, magnetite, rutile and ilmenite. These vanadium ores are complex ores which are admixtures containing iron and many other components, such as for example as any of the following: titanium, copper, aluminum, magnesium, and phosphorus, in addition to vanadium.

One of the technical advantages of the present methods and systems is that they can be used for selective extraction of specifically iron and vanadium from these complex admixtures that contain other metals in addition to vanadium and iron. Another technical advantage is that present methods may be used to separate vanadium from iron from a vanadium ore. Unexpectedly, the present methods provide a high extraction yield for both metals, iron and vanadium, from the vanadium ores. In some preferred embodiments of the methods, the extraction yield for each of vanadium and iron, independently from each other, may be at least 85 wt%, and more preferably at least 90 wt%, and most preferably at least 95 wt% and even higher.

In the present methods, a vanadium ore that contains iron and vanadium is reacted with a gas mixture comprising carbon monoxide and chlorine in the presence of carbon dioxide which is used as carrier gas.

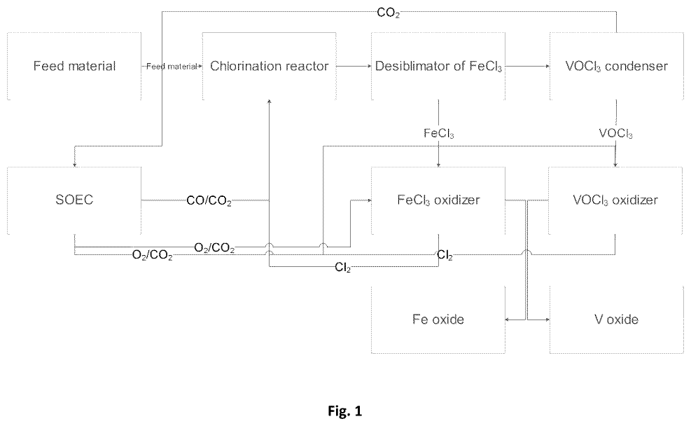

Referring to FIG. 1, pelletized and dried feed material, preferably a vanadium ore, is fed to a chlorination reactor, where the ore is chlorinated with a chlorine/CO/CO₂ gas mixture. FeCl₃ is desublimated from the exhaust gas mixture and oxidized with a O₂ /CO₂ gas mixture to produce iron oxide and chlorine. VOCl₃ is condensed and oxidized with a O₂ /CO₂ gas mixture to produce iron oxide and chlorine. Chloride-depleted gas mixture, consisting mainly of CO₂, is directed to a solid oxide electrolysis cell (SOEC) where it is converted to a CO/CO₂ gas mixture to be used again in the chlorination reactor and a O₂ /CO₂ gas mixture to be used in two oxidizers. The chlorination reaction is conducted at an elevated temperature in a first temperature zone, preferably at a temperature in the range from about 850 to about 1000° C., producing a mixture of volatile metal chlorides comprising iron chloride (FeCl₃) and vanadium oxytrichloride (VOCl₃).

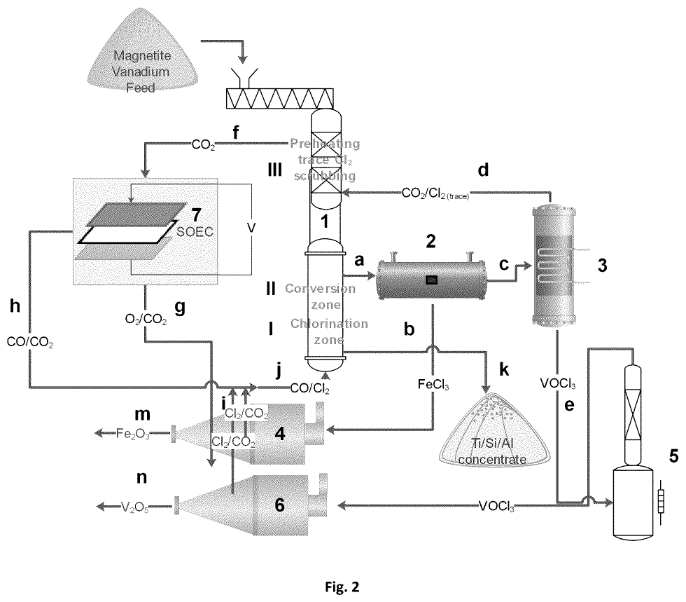

Referring to FIG. 2, methods according to this disclosure may be conducted in a system depicted in FIG. 2. A process for selective extraction of vanadium and iron with maximum recycling of reagent gases, including CO₂ capture, is disclosed. As shown in FIG. 2, a system for carrying out extraction and separation includes:
a chlorination reactor 1 having three different temperature zones: chlorination I, conversion II, and scrubbing III,
one or more desublimators 2,
one or more condensers 3,
oxidizers 4 and 5, and
a solid oxide electrolysis cell (SOEC) 7.

The system may further include one or more liquid storage tanks for collecting and storing liquid vanadium oxytrichloride.

Preferably, the reactor 1 is a chamber having a volume enclosed by a wall and having a length from a bottom to a top of the chamber. Heating zones I, II and III are located one after another along the length of the chamber with the heating zone I (the chlorination zone) being the closest to the bottom of the reactor 1, followed by the heating zone II (the conversion zone) in the middle and then the heating zone III (the scrubbing zone) being located the closest to the top of the reactor 1.

As can be seen in FIG. 2, a dried and pelletized feed material such as a vanadium ore is fed to the heated, preferably heated electrically, reactor 1. In the embodiment of FIG. 2, the material is fed from the top of the reactor 1 through an inlet into the reactor 1. The feed material is then moved through zones III, II and I to the bottom of the reactor 1. In other embodiments, the feed material may be fed to the reactor 1 at any other location so long as the feed material is delivered to zone I, wherein the feed material reacts with a mixture of carbon monoxide and chlorine j to produce a mixture of volatile chlorides, predominantly metal chloride of vanadium and iron. Carbon dioxide is used as a carrier gas. The chlorination reaction is exothermic, and the temperature in this zone may be maintained between 850 and 1000° C. The produced gas mixture is moving upward to zone II, where other metal chlorides, including chlorides of Si, Al and Ti, if present in the feed material, are converted to not volatile species. The preferred temperature in zone II is between 750 and 550° C. After passing zone II, the gas mixture mostly contains VOCl₃, FeCl₃ and CO₂ with a trace amount of chlorine. This gas mixture a exits reactor 1 through an exhaust line into iron chloride desublimator 2. In desublimator 2, iron trichloride is precipitated as solid crystals and collected on the bottom of desublimator 2. A minimum of two desublimators or more desublimators may be used in the system; when a first desublimator is full, the gas stream from the reactor may be directed to a second desublimator (not shown in FIG. 2), and the first desublimator is heated to evaporate FeCl₃ (gas stream b). Preferably, the desublimator may be heated to a temperature in the range from about 320 to about 350° C.

The mixture of CO₂ and O₂ g is used as a carrier gas to remove FeCl₃ vapours from desublimator 2. Iron trichloride is burned in oxidizer 4 to produce iron oxide and chlorine. Chlorine and carbon dioxide gas mixture i is mixed with CO/CO₂ gas mixture h and directed to reactor 1. Preferably, the oxidation reaction may be carried out at a temperature in the range from about 550 to about 1100° C.

From the desublimator 2, an iron chloride depleted gas mixture c is passed to and through vanadium oxytrichloride condenser 3. VOCl₃ is liquified and sent to liquid storage tank 5. Preferably, the condensation reaction may be carried out at a temperature in the range from about 0 to about 5° C.

A minimum of two liquid storage tanks are used in the process. When one storage tank is full, stream e is directed to the second one. A full liquid storage tank is heated, and VOCl₃ is evaporated and passed through a purification column. The mixture of CO₂ and O₂ g may be used as a carrier gas to bring VOCl₃ to oxidizer 6, where VOCl₃ is burned to vanadium oxide. Preferably, the oxidation reaction may be carried out at a temperature in the range from about 550 to about 1100° C. Produced chlorine gas mixture i is passed to reactor 1.

In the reactor 1, depleted of metal chlorides gas mixture d is passed through reactor zone III, where most of the chlorine contamination is removed. The preferred temperature in zone III is between 450 and 350° C. After passing through zone III, the gas mixture f contains mainly CO₂ and is directed to SOEC 7, where it is converted to CO and O₂ (gas mixtures g and h). The solid exiting from reactor 1 through a screw conveyor (stream k) may contain mostly Si, Ti, Al, Mg, Ca and other oxides and can be safely disposed of or used as feed material for the production of Ti, Al or Si.

The invention will now be further described by the following non-limiting examples.

### Example 1

Dried and pelletized to 5-10 mm pellets 1 Kg of feed material with a composition of 2.93% Al, 1.12% Ca, 55.9% Fe, 0.79% Mg, 2.55% Si, 6.78% Ti and 1.21% V was placed to a chlorination reactor equipped with two inlet and two outlet gas nozzles and 3 zone electrical heaters, as shown in FIG. 2. The reactor was purged with CO2 to remove air. The reactor's heating zones were heated as follows: to 950° C. in zone (I), 750° C. in zone 2 (II) and 550° C. in zone 3 (III).

After the designated temperatures were achieved, a CO/CO₂ /Cl₂ gas mixture in the 1:1:1 ratio by volume was introduced to the reactor through the gas nozzle at the bottom of the reactor. The flow of the gas mixture was maintained at 3 L/min. After the chlorination reaction started, a temperature in zone I was increased to 980° C. After the exothermic reaction moved upward the reactor, the feed material was introduced at the top of the reactor through a rotary feeder and reacted residue was removed from the bottom of the reactor using a screw conveyor. The flow of the feed material was adjusted to maintain the exothermic reaction in middle zone I.

Iron trichloride was collected in a first desublimator 2 equipped with a level switch. The temperature of the desublimator was kept at 130° C. When the FeCl₃ collector at the bottom of the desublimator was ¾ full, the reactor exhaust gas mixture was switched to the second desublimator. The first desublimator was heated to 330° C., and a CO₂ /O₂ gas mixture with a ratio of ⅓ was passed through the desublimator and to the iron trichloride oxidizer 4. The temperature of the iron trichloride oxidizer was maintained above 1000° C. FeCl3 depleted gas mixture went to a first VOCl₃ condenser, and condensed VOCl₃ was collected in a storage tank equipped with a level switch. The temperature of the condenser was kept below −5° C. When the storage tank was ¾ full, the exhaust gas mixture d was switched to a second condenser. The storage tank was heated to 150° C. with CO₂ /O₂ (⅓) gas mixture used as a carrier gas. VOCl₃ gas was burned in VOCl₃ oxidizer 6. The temperature of the oxidizer was maintained above 1000° C. VOCl₃ depleted gas mixture was directed back to the chlorination reactor 1 above heating zone II through the gas nozzle. The gas mixture exited the reactor at the top. The concentration of chlorine compounds in the exhaust gas stream f was below 300 ppm and was suitable for conversion to carbon monoxide in solid oxide electrolysis cell (SOEC) (7).

The SOEC unit was equipped with two gas pumps to maintain flow through the reactor and two oxidizers. The residue from chlorination reactor 1 was analyzed and had a typical composition of 8% Al, 3% Ca, 8% Fe, 2% Mg, 10% Si, 23% Ti, and 0.2% V. This composition corresponded to the extraction yields of 96% for Fe and 96% for V.

1. A method for extracting vanadium and iron from a vanadium ore containing at least vanadium and iron, the method comprising:
i. reacting the vanadium ore with a gas mixture comprising carbon monoxide (CO) and chlorine (Cl₂) in the presence of carbon dioxide (CO₂) at a first elevated temperature, wherein the first elevated temperature is in the range from about 850 to about 1000 ° C. and thereby producing a mixture of volatile metal chlorides comprising iron chloride (FeCl₃) and vanadium oxytrichloride (VOCl₃);
ii. exposing the mixture obtained in step i. to a second temperature, the second temperature being in the range from about 750 to about 550 ° C. and collecting a gas mixture that comprises iron chloride (FeCl₃), vanadium oxytrichloride (VOCl₃) and carbon dioxide (CO₂);
iii. passing the gas mixture collected in step ii. through a desublimator and precipitating iron chloride solid crystals from the gas mixture, thereby depleting the gas mixture of iron chloride;
iv. passing the gas mixture obtained in step iii. which comprises vanadium oxytrichloride (VOCl₃) and carbon dioxide (CO₂), but is depleted of iron chloride (FeCl₃) through a vanadium oxytrichloride condenser and producing liquid vanadium oxytrichloride;
V. oxidizing iron chloride solid crystals obtained in step iii. in the presence of a carbon dioxide and oxygen gas mixture into iron oxide; and
vi. oxidizing vanadium oxytrichloride obtained in step iv. in the presence of a carbon dioxide and oxygen gas mixture into vanadium oxide.

2. The method of claim 1, wherein the vanadium ore is one or more of the following: titanomagnetite, magnomagnetite, magnetite, rutile, ilmenite, or any mixture thereof.

3. The method of claim 1, wherein the method further comprises: recycling carbon dioxide and producing a CO/CO₂ gas mixture and/or O₂ /CO₂ gas mixture in a solid oxide electrolysis cell (SOEC).

4. The method of claim 1, wherein the method further comprises recycling carbon monoxide.

5. The method of claim 1, wherein steps i. and ii. are performed in a chlorination reactor operating at 3 different temperature zones, a first temperature zone being used for carrying step i; a second temperature zone being used for carrying step ii and a third temperature zone being used for scrubbing carbon dioxide prior to recycling it, wherein the third temperature zone is operated preferably at a temperature range from about 450 to about 350 ° C.

6. The method of claim 1, wherein step i. is performed with carbon monoxide (CO) and chlorine (Cl₂) in the presence of carbon dioxide (CO₂) mixed at a ratio 1:1:1 by volume.

7. The method of claim 1, wherein the desublimator in step iii. is operated at a temperature in the range from about 120 to about 150°C.

8. The method of claim 1, wherein the vanadium oxytrichloride condenser in step iv. is operated at a temperature in the range from about −10 to about +5°C.

9. The method of claim 1, wherein carbon dioxide and/or carbon monoxide are recycled through a close-loop capture.

10. A system for extracting vanadium and iron from a vanadium ore and separating vanadium from iron, the system comprising:
a chlorination reactor 1 having three different temperature zones: chlorination I, conversion II, and scrubbing III, wherein the chlorination reactor is a chamber having a volume enclosed by a wall and having a length from a bottom to a top of the chamber, and wherein the three zones are located along the length of the reactor, one after another, the chlorination zone I being the closest to the bottom of the reactor, followed by the conversion zone II in the middle and the scrubbing zone III be located after the conversion zone II, the scrubbing zone III being the closest to the top of the reactor;
one or more desublimators 2,
one or more condensers 3,
oxidizers 4 and 5, and
a solid oxide electrolysis cell (SOEC) 7.

11. The system of claim 10, wherein the system further comprises one or more liquid storage tanks for collecting and storing liquid vanadium oxytrichloride.

12. The system of claim 10, wherein the chlorination reactor contains one or more inlets for receiving the vanadium ore and wherein the inlets are located at or near the top of the reactor and wherein the system further includes a conveyor capable of moving the vanadium ore from the top to the bottom of the reactor.

13. The system of claim 10, wherein the reactor includes an exhaust line which can be connected to an outlet gas nozzle of the reactor, the exhaust line capable of connecting the reactor to one or more desublimators, the exhaust line being used for removing a gas mixture that comprises iron chloride (FeCl₃), vanadium oxytrichloride (VOCl₃) and carbon dioxide (CO₂) from the conversion Zone II of the reactor to one or more desublimators.

14. The system of claim 10, wherein the one or more desublimator further includes an exhaust line for connecting the one or more desublimators to one or more vanadium oxytrichloride condensers, the exhaust line being an outlet from the desublimator and suitable for passing an iron chloride depleted gas mixture from the desublimator to the vanadium oxytrichloride condenser.

15. The system of claim 10, wherein the chlorination reactor comprises one or more of the following elements:
at least two inlets, a first inlet being located at or near the bottom of the chlorination reactor, the first inlet being suitable for supplying a gas mixture comprising carbon monoxide (CO), chlorine (Cl₂) and carbon dioxide (CO₂) to the chlorination reactor, and a second inlet being located at or near the scrubbing zone III for receiving carbon dioxide for scrubbing from at least one vanadium oxytrichloride condenser;
at least two outlet gas nozzles, a first outlet gas nozzle being located in or after the conversion zone II, but before the scrubbing zone III, the first outlet gas nozzle being connectable to the exhaust line of claim 13, the first outlet gas nozzle being used for removing a gas mixture that comprises iron chloride (FeCl₃), vanadium oxytrichloride (VOCl₃) and carbon dioxide (CO₂) from the conversion Zone II of the chlorination reactor to one or more desublimators; and second outlet gas nozzle located at or near the top of the chlorination reactor for removing recycled carbon dioxide (CO2) from the chlorination reactor;
a feed material hopper to feed ore to the chlorination reactor; and/or
a screw conveyer for removing residue from the chlorination reactor.

16. The system of claim 10, wherein the desublimator includes a heat exchange unit and a bottom storage space for iron chloride solid crystals.

17. The system of claim 10, wherein the condenser includes a storage tank and purification column.

18. The system claim 10, wherein the SOEC unit is equipped with at least two gas pumps.

19. A use of the system of claim 10, for performing the following method:
continuously feeding solid pellets to the chlorination reactor from the feed bin at the top of the reactor;
moving feed pellets downward through three heating zones of the reactor: scrubbing, conversion and chlorination;
introducing a gas mixture of Cl₂ /CO/CO₂ from the bottom of the reactor and chlorinating feed material pellets in the chlorinating zone;
passing produced a gaseous mixture of metal chlorides through heated feed material in the conversion zone and removing all metal chlorides except for FeCl₃ and VOCl₃;
withdrawing a purified gas mixture containing FeCl₃ and VOCl₃ using a gas outlet line located above the conversion zone;
passing the gas mixture through FeCl₃ one of two desublimators and precipitating solid iron trichloride;
switching to the second desublimator when the first desublimator is full and subliming FeCl₃ from a desublimator to an iron chloride oxidizer and producing iron oxide;
condensing VOCl₃ in a liquid condenser and discharging liquid VOCl₃ into a storage tank;
evaporating VOCl₃ from the storage tank through purification column to VOCl₃ oxidizer and producing vanadium oxide;
passing an exhaust gas mixture through heated feed in the scrubbing zone to remove traces of chlorine compounds;
using the resulting cleaned gas mixture to convert CO₂ to CO/CO₂ and O₂/CO₂ gas mixtures;
recycling produced CO/CO₂ gas mixture to Cl₂ /CO/CO₂ gas stream for use in chlorination reactor;
using O₂/CO₂ in iron chloride and VOCl₃ oxidizers to produce iron and vanadium oxides and chlorine gas; and
recycling produced chlorine gas to Cl₂ /CO/CO₂ gas stream for use in chlorination reactor.
